(19) United States
(12) Patent Application Publication
(10) Pub. No.: US 2003/0017015 A1
(43) Pub. Date: Jan. 23, 2003

(54) Cutting tool and methods of making and reconditioning thereof

(76) Inventor: Donald L. Strubler, Rock Hill, SC (US)

Correspondence Address: Philip E. Levy, Esq., Metz Schermer & Lewis, LLC, 18th Floor, 11 Stanwix St., Pittsburgh, PA, 15222, US

(21) Appl. No.: 09/908,114

(22) Filed: Jul. 18, 2001

(51) Int. Cl. B23B 51/02

(52) U.S. Cl. 408/230; 408/144; 76/108.6

(57) ABSTRACT

A cutting tool is provided with a margin that includes a modified margin portion adjacent the terminal end of a circumferential face of the cutting tool that is smaller in width than the width of the base portion of the margin. The cutting tool is manufactured from a blank by removing portions of the blank to create flutes and interposed circumferential faces. A recessed portion on the circumferential faces is created to provide the margins, a point is provided at the cutting end, and a portion of the margin is removed on at least one of the circumferential faces between the terminal end of the circumferential face and a distance L from the terminal end. A cutting tool may be provided with a modified margin during reconditioning of the cutting tool. The modification may be done before or after the removal of worn or damaged sections of the cutting tool.

### FIELD OF THE INVENTION

The present invention relates to a cutting tool having increased resistance to wear and, in particular, to a drill bit or drill insert having a modified margin, and methods of making and reconditioning a cutting tool to include such a modified margin.

### BACKGROUND AND DESCRIPTION OF THE PRIOR ART

Drill bits are typically manufactured from materials such as steel alloys and, more recently, from tungsten-carbide alloys. Drill bits are manufactured to standard specifications, which have been developed in the industry based on experience with drill bits made from steel alloys. The specifications are based upon the gross dimensions of the drill bit, and include the overall length, flute, shank length, back taper, and margin.

Drill inserts are typically manufactured from tungsten-carbide alloys. Drill inserts follow similar geometries to drill bits, but consist only of the cutting end of a drill bit. Drill inserts are designed to mount onto tool holders, which are made of steel alloy. The drill insert/tool holder assembly both resembles and functions like a typical drill bit.

FIGS. 1 and 2 show front and side views of the cutting end of a typical prior art drill bit 2. The drill bit 2 includes flutes 4 in the form of twisted grooves that extend from the cutting edges 6 along the length of the drill bit 2 to the mount end of the shank portion (not shown) of the drill bit 2. The number of flutes 4 corresponds to the number of cutting edges 6 on the drill bit 2. Each cutting edge 6 merges into a chisel edge 12. Located between the flutes 4 are circumferential faces 10. At the tip end of the circumferential faces 10 and corresponding thereto are the flanks 13. Located between each flute 4 and flank 13 is the web thinning 11. Each circumferential face 10 includes a margin 8 extending integrally along an edge thereof, and a face portion 9 adjacent to the margin 8. The face portions 9 are recessed with respect to the margins 8.

The margins 8, which have a substantially uniform width W (shown in FIG. 2), begin at the cutting edges 6 and run along the length of the drill bit 2 to the mount end of the shank portion (not shown) of the drill bit 2. The margins 8 function to add stability to the drill bit 2 during operation by creating a line of contact between the drill bit 2 and the surface being cut. The cutting points 7 on the drill bit 2 are located at the intersection of the cutting edges 6 and the leading edge of the margins 8.

FIG. 3 shows side views of a prior art drill insert 2′ and a prior art tool holder 2″ upon which the drill insert 2′ may be removably affixed. The drill insert 2′ corresponds to the cutting end of a typical prior art drill bit such as the prior art drill bit 2 shown in FIGS. 1 and 2. The drill insert 2′ includes flutes 4′ in the form of twisted grooves. The number of flutes 4′ corresponds to the number of cutting edges 6′ on the drill insert 2′. Each cutting edge 6′ merges into a chisel edge 12′. Located between the flutes 4′ are circumferential faces 10′, and corresponding thereto are the flanks 13′. Located between each flute 4′ and flank 13′ is the web thinning 11′. Each circumferential face 10′ includes a margin 8′ and a face portion 9′ adjacent to the margin 8′ . The face portions 9′ are recessed with respect to the margins 8′. As is the case with the prior art drill bit 2, the margins 8′ have a substantially uniform width W.

The drill insert 2′ is adapted to be removably affixed to the tool holder 2″ at the receiving end 3″ by attaching means 3′. Any suitable attaching means 3′ such as a cam lock, back side screws, or set screws may be used to removably affix the drill insert 2′ to the tool holder 2″. The tool holder 2″ corresponds to the upper portion of a typical prior art drill bit such as prior art drill bit 2. The tool holder 2″ includes flutes 4″ that extend from the receiving end 3″ of the tool holder 2″ to the mount end of the shank portion (not shown) of the tool holder 2″. The number of flutes 4″ corresponds to the number of flutes 4′ on the drill insert 2′. Located between the flutes 4″ are circumferential faces 10″. The flutes 4″ and circumferential faces 10″ correspond to like elements on the drill insert 2′, and are adapted to be in alignment therewith when the drill insert 2′ is affixed to the tool holder 2″.

All cutting tools have a limited useful life. The end life of a drill bit or drill insert occurs when it either fails or wears out. Failure of a drill bit or drill insert usually occurs when the drill bit or drill insert breaks due to catastrophic failure of the material from which the drill bit or drill insert is manufactured. By contrast, a drill bit or drill insert that is worn out has essentially become too dull to cut. The two major causes of failure and wear in a drill bit or drill insert are heat and friction, which arise during normal operation of the drill bit or drill insert.

The useful life of a cutting tool such as a drill bit or drill insert that has failed or become worn out can sometimes be extended by subjecting the cutting tool to a reconditioning process, which is well known in the prior art. With reference to FIGS. 1 and 2, in the reconditioning process, the tip of a drill bit 2, consisting of the cutting edges 6, chisel edge 12, flanks 13, and web thinning 11, is ground down to remove any portion of the tip that is worn or damaged, and a new tip is fashioned on the drill bit. The effect of the reconditioning is to return the drill bit to its original operational specifications. Although the reconditioning process is described herein with respect to prior art drill bit 2, it will be appreciated that the same prior art reconditioning process may be applied to drill inserts.

The number of times a drill bit can undergo reconditioning before it must be replaced will depend on the acceptable tolerances for the drill bit in light of the applications for which it is to be used. One of the common tolerances for drill bits relates to the fact that drill bits are typically tapered such that the diameter of the bit is larger at the cutting point. This taper allows the bit to rotate freely in the hole being cut thereby. One significant limitation of the reconditioning process is that each successive removal of cutting tip material reduces the overall diameter of the bit. As a result, the hole that is created by the drill bit may be smaller than desired. Reconditioning can occur only as long as the diameter remains within the specified tolerance for this dimension. It should be noted, however, that in some applications, the flute length or overall length of the drill bit, not the overall diameter of the bit, are the tolerances that limit the number of times a drill bit may be reconditioned.

### SUMMARY OF THE INVENTION

Described is a cutting tool having a plurality of flutes and circumferential faces located between the flutes. Each circumferential face includes a margin that extends integrally along an edge thereof, and a recessed portion adjacent to the margin. The margin of at least one of the circumferential faces includes a modified margin portion and a base margin portion adjacent to the modified margin portion. The modified margin portion and base margin portion meet at an intersection zone. The width of the modified margin portion is less than the width of the base margin portion at the intersection zone. The width of the modified portion may decrease between the intersection zone and the terminal end of a circumferential face in such a way that the modified margin portion has a straight lateral face or an arcuate lateral face. Alternatively, the width of the modified margin portion may be substantially uniform between the intersection zone and the terminal end of a circumferential face. The modification to the margin as described above reduces the friction experienced by the cutting tool during operation by reducing the area of the cutting tool that is contact with the material being cut. The reduction in friction extends the life of the cutting tool by reducing the wear on the cutting tool. Specific embodiments of the cutting tool of the present invention include drill bits and drill inserts.

Also described is a drill insert that may be removably affixed to a tool holder. The tool holder includes a plurality of flutes and a plurality of circumferential faces that are located between the flutes. Likewise, the drill insert includes a plurality of flutes and a plurality of circumferential faces that are located between the flutes. In addition, the circumferential faces on the drill insert may have a margin that decreases in width between the mount end and terminal end of a circumferential face. In particular, the width of the margin may decrease between the mount end and terminal end of a circumferential face in such a way that the margin has a straight lateral face or an arcuate lateral face.

Also described is a method of making a cutting tool from a cutting tool blank that includes the steps of (i) removing first portions of the cutting tool blank to form a plurality of flutes, which step defines a plurality of circumferential faces located between the flutes, (ii) removing a portion of each of the circumferential faces to form a recessed portion on each of the circumferential faces, which step defines a margin on each of the circumferential faces, (iii) removing a second portion of the cutting tool blank to form a point, and (iv) removing a portion of the margin of at least of one of the circumferential faces between the terminal end of the circumferential face and a distance L from the terminal end. The portions removed in step (iv) may be triangular, arcuate, or rectangular in shape. In addition, the removing step may be performed before or after a web thinning step.

Also described is a method of reconditioning a cutting tool having a tip and a plurality of circumferential faces having margins that includes the steps of (i) removing worn or damaged portions of the tip and (ii) removing a portion of the margin of at least one of the circumferential faces between a terminal end of the circumferential face and a distance L from the terminal end. The portions removed in step (ii) may be triangular, arcuate, or rectangular in shape.

Also described is a method of reconditioning a cutting tool having a tip and a plurality of circumferential faces having margins that includes the steps of (i) estimating a point P at which at least one of the circumferential faces would begin after the drill bit is reconditioned, (ii) removing a portion of the margin of at least that circumferential face between the point P and a distance L from the point P, and (iii) removing worn or damaged portions of the tip after steps (i) and (ii) are complete. The portions removed in step (ii) may be triangular, arcuate, or rectangular in shape.

### BRIEF DESCRIPTION OF THE DRAWINGS

Further features and advantages of the present invention will be apparent upon consideration of the following detailed description of the present invention, taken in conjunction with the following drawings, in which like reference characters refer to like parts, and in which:

FIG. 1 is a front view of a prior art drill bit;

FIG. 2 is a side view of the prior art drill bit shown in FIG. 1;

FIG. 3 is a side view of a prior art drill insert and a prior art tool holder upon which the drill insert may be removably affixed;

FIG. 4 is a front view of a first embodiment of a drill bit of the present invention;

FIG. 5 is a side view of the drill bit shown in FIG. 4;

FIG. 6 is an enlarged view of the tip of the drill bit shown in FIGS. 4 and 5;

FIG. 7 is an enlarged side view of the tip of a drill bit according to a second embodiment of the present invention;

FIG. 8 is an enlarged side view of the tip of a drill bit according to a third embodiment of the present invention; and

FIG. 9 is a side view of a drill insert and tool holder upon which the drill insert may be removably affixed according to a fourth embodiment of the present invention.

### DESCRIPTION OF THE PREFERRED EMBODIMENTS

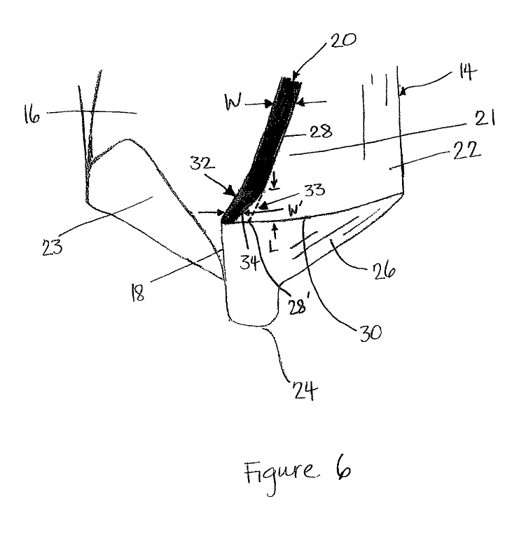

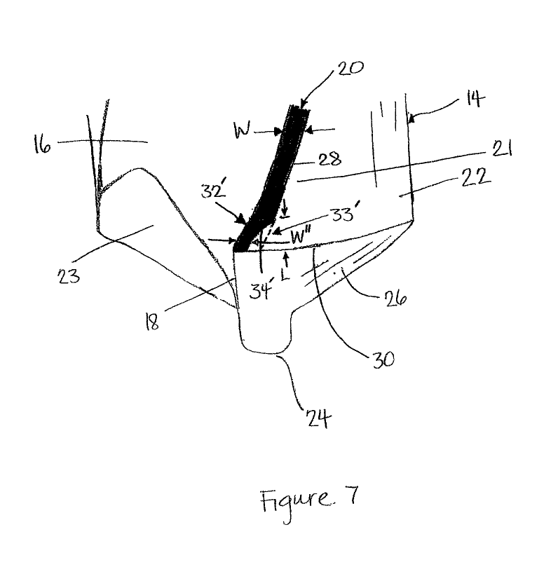

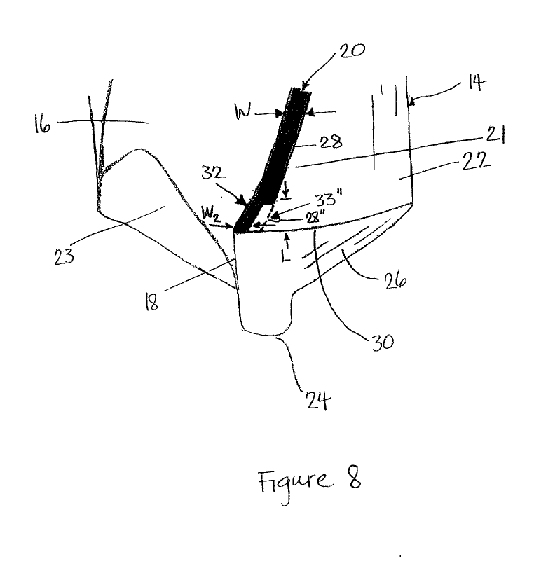

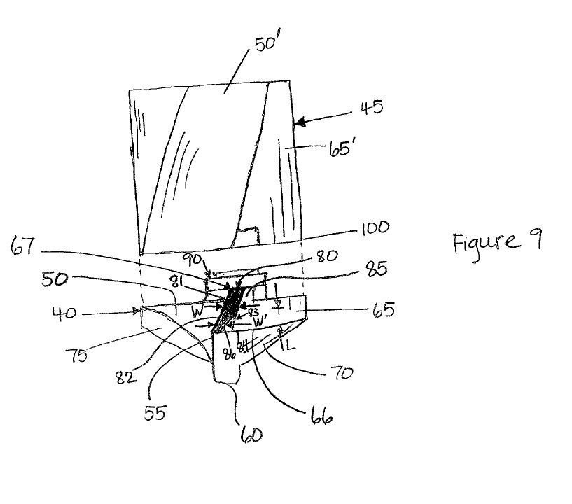

A drill bit 14 according to a first embodiment of the present invention is shown in FIGS. 4-6. The drill bit 14 includes flutes 16 in the form of twisted grooves that extend from the cutting edges 18 along the length of the drill bit 14 to the mount end of the shank portion (not shown) of the drill bit 14. The number of flutes 16 corresponds to the number of cutting edges 18 on the drill bit 14. Each cutting edge 18 merges into a chisel edge 24. Located between the flutes 16 are circumferential faces 22. At the tip end of the circumferential faces 22 and corresponding thereto are the flanks 26. Located between each flute 16 and flank 26 is the web thinning 23. Each circumferential face 22 may include a margin 20 extending integrally along an edge thereof, and a face portion 21 adjacent to the margin 20. The face portions 21 are recessed with respect to the margins 20.

As shown in FIG. 6, the margin 20 consists of a base margin portion 28 and a modified margin portion 32. The base margin portion 28 is provided beginning at a distance L from the terminal end 30 of the circumferential faces 22 and extends along the length of the drill bit 14 to the mount end (not shown). In the embodiment shown in FIG. 6, the base margin portion 28 has a substantially uniform width W, as is the case with the prior art drill bit 2. As one of skill in the art will appreciate, however, the extent of the uniformity of the width W of the base margin portion 28 along the length of the drill bit 14 will depend on the method of manufacture of the drill bit 14. A bit that is manufactured using a process such as press-molding may have a base margin portion 28 having a width W with a higher degree of deviation along the length of the bit as compared to a bit manufactured using a grinding process. Alternatively, the base margin portion 28 may have a width W that varies along the length of drill bit 14.

The modified margin portion 32 and the base margin portion 28 meet at an intersection zone 38. The modified margin portion 32 is characterized by having a width W′ at all points therealong that is less than the width W of the base margin portion 28 at the intersection zone 38. Thus, the modified margin portion 32 begins at the point in the intersection zone 38 where the width of the modified margin portion 32 is less than the width of base margin portion 28, and extends to the terminal end 30 of the circumferential faces 22. The degree to which the width W′ is smaller than width W may vary depending on the particular application for the drill bit 14. In all cases, however, the modified margin portion 32 should be wide enough to provide for stability and dissipation of heat during operation of the drill bit 14. Similarly, distance L will depend on the particular application for the drill bit 14. For example, drill bits that are subjected to side loads during operation will have a shorter distance L in order to stabilize the drill bit by increasing the surface area of the base margin portion 28.

As seen in FIG. 6, the modified margin portion 32 gradually tapers and decreases linearly in width W′ from the point in the intersection zone 38 where the modified margin portion 32 begins to the terminal end 30 of the circumferential face 22 in such a way that recessed margin portion 33, indicated by the area between the modified margin portion 32 and recessed margin boundary 28′, shown in chain line, is triangular in shape. Alternatively stated, the recessed margin portion 33 represents the material removed to produce the modified margin portion 32 and is triangular in shape. The modified margin portion 32 is therefore provided with a straight lateral face 34.

Referring to FIG. 7, a drill bit 14 according to a second embodiment of the present invention is shown in which the modified margin portion 32′ is tapered and decreases in width W″ from the point in the intersection zone 38 where the modified margin portion 32′ begins to the terminal end 30 of the circumferential face 22 such that the modified margin portion 32′ has an arcuate lateral face 34′.

Referring to FIG. 8, a drill bit 14 according to a third embodiment of the present invention is shown in which the modified margin portion 32″ has a substantially uniform width W₂ at all points therealong that is less than the width W of the base margin portion 28 at the intersection zone 38. As seen in FIG. 8, the recessed margin portion 33″ defined by the boundaries of the modified margin portion 32″, base margin portion 28, terminal end 30 of the circumferential face 22, and margin boundary 28″, shown in chain line, is rectangular in shape.

It should be understood that FIGS. 6-8 illustrate only three examples of the shape that the modified margin portion 32 may take according to three particular embodiments of the present invention. The modified margin portion 32 may have any shape as long as the width W′, W″ or W₂ at all points along the modified margin portion 32, 32′, or 32″ is smaller than the width W of the base margin portion 28 at the intersection zone 38.

The shapes of the modified margin portions 32, 32′, and 32 ″ shown in FIGS. 6-8 are advantageous because, in the case of margin portions 32 and 32′, the fall width of the margin W is engaged gradually as the cutting tool enters a work piece, and in the case of modified margin portion 32″, the full width of the margin W is engaged only after the cutting tool has entered the distance L into the work piece.

A drill insert 40 and tool holder 45 according to a fourth embodiment of the present invention is shown in FIG. 9. The drill insert 40 corresponds to the cutting end of a drill bit. The drill insert 40 includes flutes 50 in the form of twisted grooves. The number of flutes 50 corresponds to the number of cutting edges 55 on the drill insert 40. Each cutting edge 55 merges into a chisel edge 60. Located between the flutes 50 are circumferential faces 65, and corresponding thereto are the flanks 70. Located between each flute 50 and flank 70 is the web thinning 75. Each circumferential face 65 may include a margin 80 extending integrally along an edge thereof, and a face portion 85 adjacent to the margin 80. The face portions 85 are recessed with respect to the margins 80.

The margins 80 consist of a base margin portion 81 and a modified margin portion 82. The base margin portion 81 begins at a distance L from the terminal end 66 of the circumferential faces 65 and extends along the length of the drill insert 40 to the mount end 67 of the circumferential faces 65. The base margin portion 81 has a substantially uniform width W. The modified margin portion 82 and the base margin portion 81 meet an intersection zone 105. The modified margin portion 82 is characterized by having a varying width W′ at all points therealong; that is less than the width W of the base margin portion 81 at the intersection zone 105. Thus, the modified margin portion 82 begins at the point in the intersection zone 105 where the width of the modified margin portion 82 is less than the width of the base margin portion 81. The degree to which the width W′ is smaller than width W may vary depending on the particular application for the drill insert 40. In all cases, however, the modified margin portion 82 should be wide enough to provide for stability and dissipation of heat during operation of the drill insert 40. Similarly, distance L will depend on the particular application for the drill insert 40. For example, as previously noted, drill bits that are subjected to side loads during operation will have a shorter distance L in order to stabilize the drill bit by increasing the surface area of the base margin portion 81.

As seen in FIG. 9, the modified margin portion 82 gradually tapers and decreases linearly in width W′ from the point in the intersection zone 105 where the modified margin portion 82 begins to the terminal end 66 of the circumferential face 65 in such a way that recessed margin portion 83, indicated by the area between the modified margin portion 82 and the recessed margin boundary 84, shown in chain line, is triangular in shape. Alternatively stated, the recessed margin portion 83 represents the material removed to produce the modified margin portion 82 and is triangular in shape. The modified margin portion 82 is therefore provided with a straight lateral face 86.

In addition to the specific embodiment shown in FIG. 9, the modified margin portion 82 may have the same shape as the modified margin portions 32′ and 32″ as shown in FIGS. 7 and 8 in connection with the drill bit 14 of the present invention. In fact, the modified margin portion 82 may have any shape as long as the width W′ at all points along the modified margin portion 82 is smaller than the width W of the base margin portion 81 at the intersection zone 105.

The drill insert 40 is adapted to removably affixed to the tool holder 45 at the receiving end 100 by attaching means 90. As in the case of the prior art drill insert 2′, suitable attaching means 90 include a cam lock, back side screws, or set screws. The tool holder 45 corresponds to the upper portion of a drill bit. The tool holder 45 includes flutes 50′ that extend from the receiving end 100 of the tool holder 45 to the mount end of the shank portion (not shown) of the tool holder 45. The number of flutes 50′ corresponds to the number of flutes 50 on the drill insert 40. Located between the flutes 50′ are circumferential faces 65′. The flutes 50′ and circumferential faces 65′ correspond to like elements on the drill insert 40, and are adapted to be in alignment therewith when the drill insert 40 is affixed to the tool holder 45.

Alternatively, one or more of the margins 80 of the drill insert 40 may have a uniform width W that decreases from the mount end 67 to the terminal end 66 of the circumferential faces 65. In this configuration, the margin 80 has no base margin portion 81 and consists only of the modified margin portion 82. Thus, the distance L runs from the terminal end 66 of the circumferential faces 65 and extends along the length of the drill insert 40 to the mount end 67 of the circumferential faces 65. In this alternative configuration, the margin 80 may have a modified margin portion 82 having a lateral face 86 that is straight or arcuate in shape.

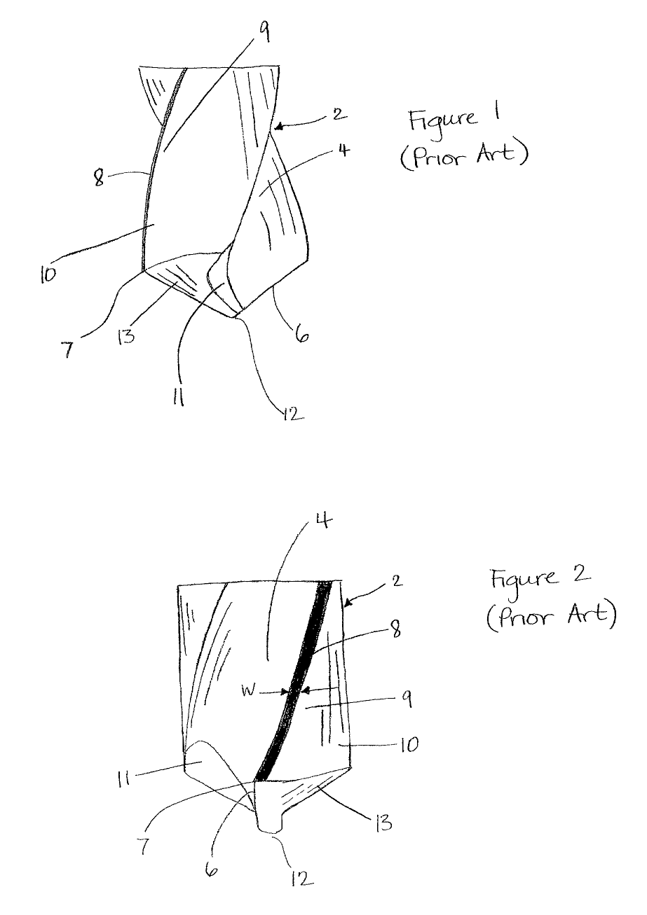

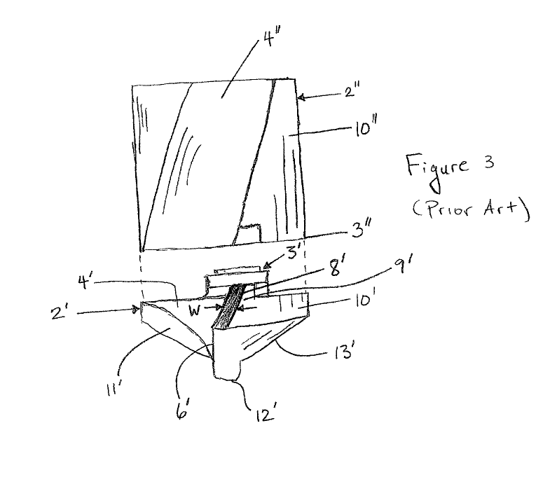

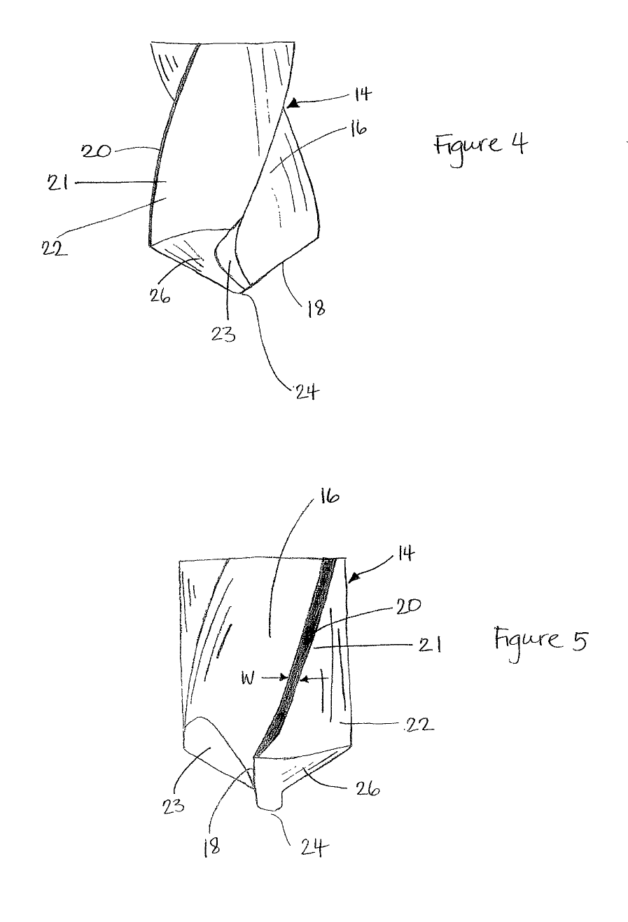

The basic steps of manufacturing a cutting tool such as drill bit 2 shown in FIGS. 1 and 2 beginning with a solid cylindrical drill blank include the following well known steps: (1) grinding the shank diameter, (2) grinding the back taper, the leading edge of which establishes the cutting diameter, (3) grinding the flutes, (4) grinding the clearance behind the margin, (5) grinding the point, and (6) grinding the web thinning. Similarly, well known steps that combine pressing and grinding operations may be used to manufacture a drill insert such as the drill insert 2′ shown in FIG. 3. The drill bits 14 having margins 20 with modified margin portions 32 and drill inserts 40 having margins 80 with modified margin portions 82 according to the present invention may be manufactured by performing a relief grind to shape modified margin portions 32 and 82 either before or after the step of grinding the web thinning. Although grinding has been described as the method of removing material from the drill blank, it will be understood that other methods of removing material may be used to manufacture a cutting tool according to the present invention.

An example of a drill bit 14 having margins 20 with modified margin portions 32 was created using a 5-axis grinder. A chamfer grinding operation was used with a chamfer angle of 6 degrees, and a clearance angle of 5 degrees. The drill bit 14 was rotated upward approximately 8 degrees to allow the grinding wheel of the grinder to pass below the cutting edge 18 of the drill bit 14. The amount of material ground away, and thus the size of modified margin portion 32, may be controlled by controlling the location of the grind wheel relative to the centerline of the drill bit 14.

Alternatively, a standard drill bit, such as the prior art drill bit 2, or a standard drill insert, such as the prior art drill insert 2′, may be modified during reconditioning to include a modified margin portion 32 on one or more of its margins 8 or a modified margin portion 82 on one or more of its margins 8′. In such a case, the relief grind would preferably be done after the new point has been created. The relief grind may also be done prior to the reconditioning of the drill bit. For example, assuming the drill bit 14 shown in FIG. 6 was to be reconditioned, a point P at which the terminal ends 30 of the circumferential faces 22 will be located after the reconditioning is complete; i.e., after the damaged and/or worn portion of the tip of the drill bit 2 has been removed, is first estimated. Next, the recessed margin portion 33 on one or more the margins 20 between the point P and a distance L′ from the point P is removed. The reconditioning process then follows.

The drill bits 14 provided with the modified margin portion 32 and drill inserts 40 provided with the modified margin portion 82 possess certain advantageous properties over the prior art drill bits such as drill bit 2 and prior art drill inserts 2′. The modified margin portions 32 and 82 function to reduce friction during cutting by reducing the area of the drill bit that is contact with the material being cut. The reduction in friction results in a concomitant reduction in heat generated during cutting. The reduction in friction also extends the life of the drill bit by reducing the wear on the drill bit.

While the present invention has been described with respect to two particular types of cutting tools, namely drill bits and drill inserts, the invention applies equally to any cutting tool having a geometry that includes a margin as described herein, such as reamer. A reamer is typically used for finish machining a hole that has been created by a drill bit.

The terms and expressions that have been employed herein are used as terms of description and not as limitations, and there is no intention in the use of such terms and expressions of excluding equivalents of the features shown and described or portions thereof, it being recognized that various modifications are possible within the scope of the invention claimed. Although particular embodiments of the present invention have been illustrated in the foregoing detailed description, it is to be further understood that the present invention is not to be limited to the embodiments disclosed, but that they are capable of numerous rearrangements, modifications and substitutions.

What is claimed is:

1. A cutting tool, comprising:
a plurality of flutes extending along a length of said tool;
a plurality of circumferential faces extending along said length of said tool, each of said circumferential faces being located between respective first and second ones of said flutes;
at least one of said circumferential faces having a margin extending integrally along an edge thereof, adjacent at least one of said flutes, said margin having a modified margin portion and a base margin portion adjacent thereto at an intersection zone, said modified margin portion having a width less than the width of said base margin portion at said intersection zone; and
a recessed portion of said at least one said circumferential faces adjacent said margin.

2. A cutting tool according to claim 1, the width of said base margin portion being substantially uniform along the entire length thereof.

3. A cutting tool according to claim 1, wherein the width of said modified margin portion decreases between said intersection zone and a terminal end of said at least one of said circumferential faces.

4. A cutting tool according to claim 3, wherein the width of said modified margin portion decreases linearly such that said modified margin portion has a straight lateral face.

5. A cutting tool according to claim 3, said modified margin portion having a lateral face having an arcuate shape.

6. A cutting tool according to claim 1, said modified margin portion having a lateral face having an arcuate shape.

7. A cutting tool according to claim 1, the width of said modified margin portion being substantially uniform between said intersection zone and the terminal end of said at least one of said circumferential faces.

8. A cutting tool according to claim 1, said cutting tool comprising a drill bit.

9. A cutting tool according to claim 1, said cutting tool comprising a drill insert, further comprising a tool holder coupled to said drill insert.

10. A cutting tool according to claim 1, said cutting tool comprising a drill insert coupled to a tool holder.

11. A drill insert for affixation to a tool holder, comprising:
a plurality of flutes;
a plurality of circumferential faces, each of said circumferential faces being located between respective first and second ones of said flutes;
at least one of said circumferential faces having a margin extending integrally along an edge thereof, the width of said margin decreasing between a mount end and a terminal end of at least one of said circumferential faces; and
a recessed portion of said at least one of said circumferential faces adjacent said margin.

12. A drill insert according to claim 1 1, wherein the width of said margin decreases linearly such that said margin has a straight lateral face.

13. A drill insert according to claim 1 1, said margin having a lateral face having an arcuate shape.

14. A method of making a cutting tool from a cutting tool blank, comprising the steps of:
removing a plurality of first portions of said cutting tool blank to form a plurality of flutes, said removal of said first portions defining a plurality of circumferential faces, each of said circumferential faces being located between respective first and second ones of said flutes;
removing a portion of each of said circumferential faces to form a recessed portion and a margin on each of said circumferential faces;
removing a second portion of said blank to form a cutting tool point; and
removing a portion of the margin of at least one of said circumferential faces, said portion of the margin being located between a terminal end of said at least one of said circumferential faces and a distance L from said terminal end.

15. A method according to claim 14, said removed margin portion having a triangular shape.

16. A method according to claim 14, said removed margin portion having an arcuate face.

17. A method according to claim 14, said removed margin portion having a rectangular shape.

18. A method according to claim 14, said method further comprising the step of removing a third portion of said blank to form a web thinning before said step of removing a portion of the margin of said at least one of said circumferential faces.

19. A method according to claim 14, said method further comprising the step of removing a third portion of said blank to form a web thinning after said step of removing a portion of the margin of said at least one of said circumferential faces.

20. A method of reconditioning a cutting tool having a tip and a plurality of circumferential faces having margins, comprising the steps of:
removing worn or damaged portions of said tip; and
removing a portion of the margin of at least one of said circumferential faces after said step of removing worn or damaged portions of said tip is complete, said portion of the margin being located between a terminal end of said at least one of said circumferential faces and a distance L from said terminal end.

21. A method according to claim 20, said removed margin portion having a triangular shape.

22. A method according to claim 20, said removed margin portion having an arcuate face.

23. A method according to claim 20, said removed margin portion having a rectangular shape.

24. A method of reconditioning a cutting tool having a tip and a plurality of circumferential faces having margins, comprising the steps of:
estimating a point P at which at least one of the circumferential faces would begin after the drill bit is reconditioned;
removing a portion of the margin of said at least one of said circumferential faces, said portion being located between the point P and a distance L′ from the point P; and
removing worn or damaged portions of the tip after said estimating and margin removing steps are complete.

25. A method according to claim 24, said removed margin portion having a triangular shape.

26. A method according to claim 24, said removed margin portion having an arcuate face.

27. A method according to claim 24, said removed margin portion having a rectangular shape.
